(19) United States
(12) Patent Application Publication
(10) Pub. No.: US 2024/0246324 A1
(43) Pub. Date: Jul. 25, 2024

(54) SUBSTANTIALLY TRANSPARENT FLEXIBLE FILM AND METHOD FOR PRODUCING SAME

(71) Applicant: Serge Ferrari SAS, Saint Jean De Soudain (FR)

(72) Inventor: Thomas Monier, Barberaz (FR)

(21) Appl. No.: 18/564,180

(22) PCT Filed: Mar. 28, 2022
(86) PCT No.: PCT/FR2022/050577

§ 371 Date: Nov. 27, 2023

(30) Foreign Application Priority Data
Jun. 2, 2021 (FR) 2105826

(51) Int. Cl. B32B 27/08; B32B 27/22; B32B 27/30; B32B 27/36; B32B 37/06; B32B 37/08; B32B 37/10

(52) U.S. Cl. CPC B32B 27/08; B32B 27/22; B32B 27/304; B32B 27/36; B32B 37/06; B32B 37/08; B32B 37/10; B32B 2250/03; B32B 2250/24; B32B 2250/40; B32B 2307/3065; B32B 2307/412; B32B 2307/7376; B32B 2309/02; B32B 2309/12; B32B 2327/06; B32B 2367/00

(57) ABSTRACT

A transparent multilayer flexible film includes a polyester (PET) layer sandwiched between two flame-retardant polyvinyl chloride (PVC) layers. Each PVC layer has from 25 to 45% plasticizer by weight with respect to its total weight, and includes plasticizer having phosphate, the level of phosphorus being between 0.3 and 1.0%, preferably between 0.4 and 0.8%, even more preferably between 0.5 and 0.7%, by weight with respect to the total weight of flexible film. The invention also relates to a method for producing such a multilayer flexible film.

### FIELD OF TECHNOLOGY

The invention relates to the field of flexible films which are substantially transparent to visible light, based on polymer materials. The invention more specifically relates to a substantially transparent film and having a good capacity for ageing, flexible, windable, intended to replace a rigid glass wall, typically within a modular structure, and having a good resistance to fire and to UV, as well as a low heat shrinkage, a low elongation under load, and a high tensile strength.

### BACKGROUND

Flexible or rigid films made of polymer materials are known, intended to replace a glass wall in a modular structure by ensuring the transmission function of light radiation. These films are quite specifically suitable for modular structures, such as event tents, even for blinds or pergolas. They can advantageously comprise substantially transparent polyvinyl chloride (PVC).

However, these films have numerous disadvantages, in particular by their relative mechanical fragility, the elongation under load and/or the heat shrinkage being too much. This poses a problem of losing the appearance of the structure, for example the film being deformed during welding, when it is assembled by high frequency. In addition, fire standards, more and more restrictive for these structures, are difficult to respect.

Thus, a first aim of the invention is to produce a substantially transparent flexible film, windable, having a good resistance to fire, to UV, to abrasion, as well as a low heat shrinkage, and a low elongation under load.

Moreover, substantially transparent PVC flexible films have a problem with resistance to UV over duration (or capacity for ageing), in particular by loss of transparency over time by being substantially coloured (yellowing), which is prohibitive from a commercial standpoint.

Thus, a second aim of the invention is to be able to produce substantially transparent flexible films not losing their transparency over a certain time period (a few months, typically 1 to 2 years).

Therefore, there is no satisfactory solution currently, making it possible to overcome the problems of the prior art. A need remains to have a substantially transparent film, flexible and windable, and having a good resistance to fire and to abrasion, as well as a low heat shrinkage and a low elongation under load, while having a good resistance to UV.

The invention consists of overcoming the problems of the prior art, by proposing a substantially transparent flexible film, as well as a method for producing such a film.

### SUMMARY OF THE DISCLOSURE

According to a first aspect, the invention relates to a substantially transparent multilayer flexible film, comprising a polyester (or PET) layer sandwiched between two flame-retardant polyvinyl chloride (PVC) layers (2), said film (1) being characterised in that each PVC layer (2) comprises 25 to 45% of plasticiser, by weight with respect to its total weight (i.e. by weight with respect to the total weight of the PVC layer), said plasticiser comprising phosphate, the rate of phosphorus being between 0.3 and 1.0%, preferably between 0.4 and 0.8%, even more preferably between 0.5 and 0.7%, by weight with respect to the total weight of flexible film.

By “flame-retardant PVC layer”, this means that the PVC film forming a layer within the film according to the invention comprises PVC, plasticiser and substantially no mineral filler. By “mineral filler”, this means, according to the invention, a mineral component such as kaolinite, talc, calcite, micas, baryte, silica, granulate or antimony oxide.

Preferably, the polyester is polyethylene terephthalate.

Thus, as will be explained below, the PET layer comprises a layer coming from a functionalisation layer on each of its faces. After assembly of the multilayer flexible film, this functionalisation layer is composed of what has become this polymer, which has enabled the adhesion.

According to a preferred embodiment, the phosphate comprises at least one aromatic cycle.

According to an embodiment, each PVC layer has an average thickness of between 100 and 400 μm, preferably of between 150 and 300 μm.

According to an embodiment, the PET layer in the multilayer flexible film (out of the layer coming from the functionalisation layer) has an average thickness of between 5 and 100 μm, preferably of between 10 and 80 μm.

Thus, the substantially transparent flexible film according to the invention generally has an average thickness of 205 to 900 μm, preferably of 310 to 660 μm.

By “of between X and Y”, or “from Z to T”, according to the invention, this means limits included.

According to a preferred embodiment, the plasticiser is chosen from among octyl diphenyl phosphate, 2-ethylhexyl diphenyl phosphate (for example, the commercial product Santicizer® 141 from the company Valtris), triphenyl phosphate, isopropylphenyl diphenyl phosphate, 2-isopropyl-5-methylcyclohexyl diphenyl phosphite, and mixtures thereof.

According to a particular embodiment, the plasticiser further comprises at least one linear phosphate comprising chlorine, preferably chosen from among tris(2-chloroethyl) phosphate, tris(1-chloro-2-propyl) phosphate, tris(3-chloropropyl) phosphate, and mixtures thereof. Such a compound is, for example, tris(2-chloroethyl) phosphate.

By “linear phosphate comprising chlorine”, according to the invention, this means a compound comprising at least one linear phosphate group, i.e. non-branched, and at least chlorine.

According to a preferred embodiment, the plasticiser further comprises at least one compound chosen from among dioctyl adipate (DOA), diisononyl phthalate (DINP), available for example, from the companies BASF and Exxon, diisodecyl phthalate (DIDP), dioctylterephthalate (DOTP), di(2-propylheptyl) phthalate (DPHP), 1,2-cyclohexane dicarboxylic acid (DINCH), tris(2-ethylhexyl) trimellitate (TOTM), biosourced plasticisers (such as the commercial product Polysorb® ID37 from the company Roquette), and mixtures thereof.

By “biosourced plasticiser”, this means, generally, a plasticiser of renewable and non-fossile origin.

Preferably, according to the invention, at least one PVC layer comprises 30 to 45% of plasticiser, by weight with respect to its total weight.

Particularly preferably, according to the invention, the two PVC layers are similar. By “similar”, according to the invention, this means of the same nature and of the same thickness. Thus, preferably, according to the invention, each PVC layer comprises 30 to 45% of plasticiser, by weight with respect to its total weight.

The properties of the substantially transparent film according to the invention are measured, as is known by a person skilled in the art, and as well as explained below.

The transparency is measured by normal transmission, as well as hemispheric transmission (standard EN 410). According to the invention, a film is “substantially transparent”, if the values obtained from each of the normal “normal visible transmission” and of the hemispheric “normal visible transmission” are greater than 80%, preferably between 85% and 100%, the visible transmission diffuses before being less than 10%.

The tensile strength is measured by the standard ISO 1421:2016 (2016 version in effect), a 5 cm wide test piece is pulled over a traction bench (force gauge) until break. The value measured is the maximum resistance value reached before break. The value obtained must be between 10 and 30 daN/5 cm.

The elongation under load is measured by the standard EN 15977:2011 (2011 version in effect). A 50 mm wide test piece on which two linear markers have been traced at a distance of 200 mm is suspended for 24 hours at a weight of 10 kg. After 24 hours, the elongation under load is measured, then the test piece is unhooked, it is left to rest for one hour, then the residual elongation is measured again. The elongation value obtained must be between 10 and 20% under load and between 5 and 10% residually.

The heat shrinkage is measured by the standard DIN 53377:2015-04 (2015 version), a 25 mm and 300 mm long test piece on which two linear markers are traced, distant by 200 mm, is placed in a heat chamber a 80° C. for 10 minutes. Upon exiting the heat chamber, the heat shrinkage is measured of the film under the conditions (80° C., 10 minutes). The value obtained must be between 0 and −1% in the cross-machine direction, like in the machine direction.

The resistance to fire is measured by the standard ISO 13501-1 of September 2007 (SBI or Euroclasse test). The product must first meet the standard EN ISO 11925-2 of March 2020 (“Reaction to fire tests—Ignitability of products subjected to direct impact of the flame—Part 2: Test using one single flame source” or “Small flame Euroclasse”). During this first test, the flame height must be less than 150 mm to perform the second test, which is the SBI test of the standard ISO 13501-1. The result of this second test must be B-s2-d0.

The UV ageing test is measured by the standard ASTM G154-4 (QUV) at a duration equal to 875 hours. The value measured is the change of colour of the material, with respect to the initial sample according to the grey scale (according to the standard ISO 105-A03). The result of this test must be equal to 5, 4-5 or 4, preferably 5 and 4-5.

According to a second aspect, the invention relates to a method for producing a substantially transparent multilayer flexible film according to the invention comprising the following successive steps:
(a) assembly of three films forming layers, a polyester (PET) film, having a functionalisation layer on each of its two faces, being sandwiched between two flame-retardant polyvinyl chloride (PVC) films;
(b) heating of this assembly at a temperature of between 130° C. and 190° C.;
(c) calendering (4) of the assembly of the three heated layers, the calendering pressure being between 10 and 30·10⁵ Pa;
(d) cooling of the multilayer flexible film coming from step (c).

Preferably, step (b) occurs at a temperature of between 150° C. and 175° C.

Preferably, step (c) occurs at a pressure of between 15 and 25·10⁵ Pa.

The functionalisation layer comprises at least one polymer, which is preferably a polyester or a polyester copolymer. The functionalisation layer does not necessarily have the same thickness at every point. Advantageously, this functionalisation layer enables the adhesion of the PET film on the PVC film.

Once the substantially transparent multilayer flexible film is produced, the heating and the calendering of respective steps (b) and (c) can have transformed the polymer of the functionalisation layer, which makes it more difficult to detect and characterise. The functionalisation layer is therefore thus transformed into a layer coming from a functionalisation layer.

The functionalisation layer is of average thickness, typically of 0.1 to 5 μm, for example around 2 μm. The functionalisation layer does not necessarily have the same thickness at every point.

The properties of the PET film used in the method of the invention are preferably those explained below. They are measured, as well as is known by a person skilled in the art.

The tensile strength is measured by the standard ISO 527-1:2019 (2019 version in effect). The value obtained must be between 220 and 250 MPa.

The elongation at break is measured by the standards ISO 527-1:2019 (2019 version in effect) and ISO 527-3:2018 (2018 version in effect). The value obtained must be between 110 and 130%.

The heat shrinkage is measured by the standard DIN 40634-2:2015-04 (1969 version) under the conditions (150° C., 15 minutes). The value obtained must be between 0.2 and 1.6%.

The properties of each PVC film forming a layer used in the method of the invention are preferably those explained below. They are measured, as well as is known by a person skilled in the art.

The tensile strength is measured by the standard ASTM D882-02. The value obtained must be between 25 and 30 MPa.

The elongation at break is measured by the standards ASTM D882-02. The value obtained must be between 240 and 280%.

The heat shrinkage is measured by the standard DIN 53377:2015-04 (2015 version), a 25 mm wide and 300 mm long test piece on which two linear markers are traced, 200 mm apart, is placed in a heat chamber at 80° C. for 10 minutes. At the outlet of the heat chamber, the heat shrinkage of the film is measured under the conditions (80° C., 10 minutes). The value obtained must be between 1 and −3% in the cross-machine direction as in the machine direction.

The resistance to fire is measured by the standard NF P92-503 of February 2004, M class by the electric burner and pilot flame test. The test piece is subjected to the radiation of an electric burner at 600° C., then at regular intervals to a pilot flame. During the test, the presence or the absence of drops or falls (inflamed or not) is observed. At the end of the test, the length degraded by the flames of the test piece is measured. To qualify the film, the test is performed on 8 test pieces. The result is correct, if at least 50% of the test pieces has a degraded length, less than 350 mm, and no falls or inflamed drops or particles.

According to a third aspect, the invention relates to a modular structure comprising at least one wall, wherein a multilayer film according to the invention is at least partially, even totally, present. In such a case, such a film serves as a passage for the light beams into the wall. Such a modular structure can thus be an event tent, but can also constitute an awning, a pergola, or a blind.

### BRIEF DESCRIPTION OF THE FIGURE

The way to implement the invention, as well as the advantages which arise from it, emerge from the description of the embodiment below, with reference to the accompanying FIGURE:

FIG. 1 is a schematic view of a method for producing a substantially transparent flexible film, according to the invention.

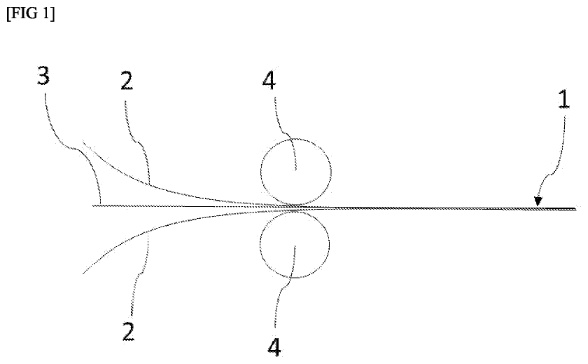

Naturally, the dimensions and the proportions of the elements illustrated in FIG. 1, have been able to be exaggerated with respect to reality, and have only been given with the aim of facilitating the understanding of the invention.

### DETAILED DESCRIPTION

The continuous production of the film 1 according to the invention, represented in FIG. 1, comprises an assembly of a PET film 3 placed between two films, in this case similar, made of flame-retardant PVC 2, a heating, then a calendering by pressurised calender rolls 4.

### EXAMPLES

Three different three-layer transparent flexible films intended to serve as a window in an event tent, one according to the invention (example 1) and two comparisons (examples no. 2 and no. 3), have been produced according to the method represented in FIG. 1. These films would have the preferred features according to the invention for PET and PVC films.

Concerning these three examples, the two PVC layers surrounding the intermediate PET layer (made of polyethylene terephthalate) were similar.

The heating has been of 160° C., and the calendering pressure has been of 25 bars (1 bar=10⁵ Pa). In each case, a controlled cooling has made it possible to manage the non-crystallisation of the PVC to keep the transparency.

The properties of two PVC single-layer transparent flexible films have been tested for comparison (comparative examples no. 4 and no. 5).

The natures and thicknesses of the tested films were as follows:

| | PVC | | PVC | | | | |
|---|---|---|---|---|---|---|---|
| | upper | | lower | | | Second | |
| | layer | | layer | | | plasticiser | |
| | (intended | | (intended | | First | compound, | |
| | to be in | | to be in | Plasticiser | plasticiser | if | |
| | contact | | contact | rate in | compound: | necessary: | Phosphorus |
| | with the | Intermediate | with the | the PVC | rate, | rate, | rate of the |
| Film | outside) | PET layer | inside) | layer | nature | nature | film |
| No. 1 | PVC film | PET | PVC film | 39% | 39.9% | 60.1% | 0.62% |
| according | 200 μm | | 200 μm | | phosphate | DINP | |
| to the | | | | | with | | |
| invention | | | | | aromatic | | |
| | | | | | cycle | | |
| No. 2 | Film | PET | Film | 37% | 69.5% | 30.5% | 1.48% |
| comparison | 300 μm | | 300 μm | | phosphate | DOTP | |
| | | | | | with | | |
| | | | | | aromatic | | |
| | | | | | cycle | | |
| No. 3 | PVC film | PET | PVC film | 40% | 100% | | 0% |
| comparison | 260 μm | | 260 μm | | DINP | | |
| No. 4 | PVC film | without | without | 40% | 100% | | 0% |
| comparison | 500 μm | | | | DINP | | |
| No. 5 | PVC film | without | without | 40% | 60.8% | 39.2% | 1.38% |
| comparison | 500 μm | | | | phosphate | DINP | |
| | | | | | with | | |
| | | | | | aromatic | | |
| | | | | | cycle | | |

It has also been proceeded by a test for producing a multilayer flexible film with two similar PVC films, 200 μm thick, and a sandwiched PET (polyethylene terephthalate) film, 15 μm thick. These films would have the preferred features according to the invention for the PET and PVC films, but the PET film was not functionalised. It has not been possible to produce a multilayer flexible film due to an adhesion defect between the PET and PVC films.

The properties obtained for the films of examples no. 1 to 5 are as follows, according to the standardised tests described above:

| | Upper | | Lower | | Elongation | Heat | |
|---|---|---|---|---|---|---|---|
| | PVC | | PVC | | under load | shrinkage | |
| | layer | | layer | | (Under | (cross- | |
| | (intended | | (intended | | load, | machine | UV ageing |
| | to be in | | to be in | Resistance | residual | direction/ | (QUV 875 |
| | contact | | contact | to fire | after 24 | machine | hours) |
| | with the | Intermediate | with the | (SBI test | hours) | direction) | (Grey scale |
| Film | outside) | PET layer | inside) | success) | (%) | (%) | scoring) |
| No. 1 | PVC film | PET | PVC film | yes | 14%, | −0.6/−0.3 | 4/5 |
| according | 200 μm | | 200 μm | | 9% | | |
| to the | | | | | | | |
| invention | | | | | | | |
| No. 2 | film | PET | film | yes | 14%, | −0.6/−0.3 | 2 |
| comparison | 300 μm | | 300 μm | | 9% | | |
| No. 3 | PVC film | PET | PVC film | no | 14%, | −0.6/−0.3 | 4/5 |
| comparison | 260 μm | | 260 μm | | 9% | | |
| No. 4 | PVC film | without | without | no | 70%, | Unknown/ | 4/5 |
| comparison | 500 μm | | | | 4% | −1.4 | |
| No. 5 | PVC film | without | without | yes | 92%, | +1/−3 | 1/2 |
| comparison | 500 μm | | | | 8% | | |

Thus, comparative examples no. 3 and no. 4 do not respectively pass the fire resistance test and the ageing test. On the other hand, comparative examples no. 4 and no. 5 do not respectively pass the elongation under load test and the elongation under load and ageing tests.

Film no. 1 according to the invention and comparative film no. 2 would have the following transmission values (%):

| | Normal | Hemispheric | |
|---|---|---|---|
| | normal visible | normal visible | Diffuse |
| | transmission | transmission | transmission |
| Film | (%) | (%) | (%) |
| No. 1 (invention) | 84 | 87 | 3 |
| before ageing | | | |
| No. 1 (invention) | 83 | 87 | 4 |
| after ageing | | | |
| No. 2 (comparison) | 87 | 89 | 2 |
| before ageing | | | |
| No. 2 (comparison) | 77 | 81 | 4 |
| after ageing | | | |

Film no. 1 according to the invention has remained transparent after ageing, while comparative film no. 2 has lost its transparency after ageing.

The results of the tests for the 5 examples are summarised below.

| | | | Heat | | |
|---|---|---|---|---|---|
| | Fire | Elongation | shrinkage | Transparency | Ageing |
| Film | property | property | property | property | property |
| No. 1 | OK | OK | OK | OK | OK |
| according | | | | | |
| to the | | | | | |
| invention | | | | | |
| No. 2 | OK | OK | OK | OK | NOK |
| comparison | | | | | |
| No. 3 | NOK | NOK | OK | OK | OK |
| comparison | | | | | |
| No. 4 | NOK | NOK | OK | OK | OK |
| Comparison | | | | | |
| No. 5 | OK | NOK | NOK | OK | NOK |
| Comparison | | | | | |

Where: OK means that the test is passed successfully, and NOK means that the test is not passed successfully.

It has therefore been observed that the film according to the invention would have a good compromise between the mechanical properties (low elongation under load and low heat shrinkage) and resistance to fire, as well as a good capacity for UV ageing.

1. A substantially transparent multilayer flexible film, comprising a polyester (PET) layer sandwiched between two flame-retardant polyvinyl chloride (PVC) layers wherein
each PVC layer comprises 25 to 45% of plasticiser, by weight with respect to its total weight, said plasticiser comprising phosphate, the level of phosphorus being between 0.3 and 1.0% by weight with respect to the total weight of flexible film.

2. A multilayer flexible film according to claim 1, wherein the polyester is polyethylene teraphthalate.

3. A multilayer flexible film according to claim 1, wherein the PET layer comprises a layer coming from a functionalisation layer on each of its faces.

4. A multilayer flexible film according to claim 1, wherein the phosphate comprises at least one aromatic cycle.

5. A multilayer flexible film according to claim 1, wherein each PVC layer has an average thickness of between 100 and 400 μm.

6. A multilayer flexible film according to claim 1, wherein the PET layer has an average thickness of between 5 and 100 μm.

7. A multilayer flexible film according to claim 1, wherein the substantially transparent flexible film according to the invention generally has an average thickness of 205 to 900 μm.

8. A multilayer flexible film according to claim 1, wherein the plasticiser is chosen from among octyl diphenyl phosphate, 2-ethylhexyl diphenyl phosphate, triphenyl phosphate, isopropylphenyl diphenyl phosphate, 2-isopropyl-5-methylcyclohexyl diphenyl phosphite, and mixtures thereof.

9. A multilayer flexible film according to claim 1, wherein the plasticiser further comprises at least one linear phosphate comprising chlorine, chosen from among tris(2-chloroethyl) phosphate, tris(1-chloro-2-propyl) phosphate, tris(3-chloropropyl) phosphate, and mixtures thereof.

10. A multilayer flexible film according to claim 1, wherein the plasticiser further comprises at least one compound chosen from among dioctyl adipate (DOA), diisononyle phthalate (DINP), diisodecyl phthalate (DIDP), dioctylterephthalate (DOTP), di(2-propylheptyl) phthalate (DPHP), 1,2-cyclohexane dicarboxylic acid (DINCH), tris(2-ethylhexyl) trimellitate (TOTM), biosourced plasticisers, and mixtures thereof.

11. A multilayer flexible film according to claim 1, wherein the two PVC layers are similar.

12. A method for producing a substantially transparent multilayer flexible film according to claim 1, comprising the following successive steps:
(a) assembly of three films forming layers, a polyester (PET) film, having a functionalisation layer on each of its two faces, being sandwiched between two flame-retardant polyvinyl chloride (PVC) films;
(b) heating of this assembly at a temperature of between 130° C. and 190° C.;
(c) calendering (4) of the assembly of the three heated layers, the calendering pressure being between 10 and 30·10⁵ Pa;
(d) cooling of the multilayer flexible film coming from step (c).

13. A method for producing a substantially transparent multilayer flexible film according to claim 12, wherein the functionalisation layer comprises at least one polymer.

14. A method for producing a substantially transparent multilayer flexible film according to claim 12, wherein the functionalisation layer is of average thickness of 0.1 to 5 μm.

15. A modular structure comprising at least one wall constituted at least of one substantially transparent multilayer flexible film, according to claim 1.
